(19) United States
(12) Patent Application Publication
(10) Pub. No.: US 2017/0011423 A1
(43) Pub. Date: Jan. 12, 2017

(54) SYSTEMS AND METHODS FOR USER DETECTION AND INTERACTION

(71) Applicant: Capital One Services, LLC, McLean, VA (US)

(72) Inventors: Lawrence DOUGLAS, McLean, VA (US); Thomas Christopher CLARKE, Alexandria, VA (US); Deborah NALLY, Williamsburg, VA (US)

(21) Appl. No.: 15/206,007

(22) Filed: Jul. 8, 2016

Related U.S. Application Data
(60) Provisional application No. 62/190,920, filed on Jul. 10, 2015.

(51) Int. Cl. G06Q 30/02; H04W 4/02; G06F 3/0482

(52) U.S. Cl. CPC G06Q 30/0261; G06F 3/0482; G06Q 30/0267; H04W 4/02

(57) ABSTRACT

Systems and methods are provided for outputting individualized targeted interaction information to a user in an environment based on detection of a device associated with the user within the environment using a plurality of sensors positioned within the environment. In some embodiments, the system includes a memory storing a set of instructions and at least one processor configured to execute the instructions to determine location information of the device based on a communication between the device and at least one of the plurality of sensors, and determine identification information of the user associated with the device. The system may access profile information associated with the user, determine targeted interaction information based on the location information of the device and the profile information associated with the user, and provide the targeted interaction information for display to the user.

### PRIORITY CLAIM

This disclosure claims priority under 35 U.S.C. §119 to U.S. provisional patent application No. 62/190,920, filed on Jul. 10, 2015. The aforementioned application is incorporated herein by reference in its entirety.

### BACKGROUND

Merchants, retailers, and other entities continuously evaluate their operations, searching for ways to improve the user experience. One such way to improve the user experience may include providing personal assistance or offering other services as the user desires. Such individual assistance, however, may require significant resources based on the size or operation of the entity. Computing systems, such as price scanners, interactive maps, etc. have been used in-store to provide certain helpful services. These systems, though, are limited in usefulness because they lack information personal to the individual user, such as knowledge of a user's needs, prior experiences, preferences, etc. These systems are also inconvenient because of their limited presence at fixed locations throughout an environment.

As mobile technologies with location sensing capability continue to develop, large amounts of data are capable of being collected regarding the user's location and other behavior patterns etc. Known technologies alone, however, are limited in the ability to determine a user's location with sufficient precision for certain applications, such as improving a user's interaction within a merchant environment, for example. Thus it would be advantageous to provide a system and method capable of providing individualized services based on a user's detected presence and interaction within a local environment.

### SUMMARY

In the following description, certain aspects and embodiments of the present disclosure will become evident. It should be understood that the disclosure, in its broadest sense, could be practiced without having one or more features of these aspects and embodiments. It should also be understood that these aspects and embodiments are merely exemplary.

Some embodiments include a system for providing individualized targeted interaction information in an environment based on detection of a device associated with the user within the environment using a plurality of sensors positioned within the environment. In some embodiments, the system includes a memory storing a set of instructions and at least one processor configured to execute the instructions to determine location information of the device based on a communication between the device and at least one of the plurality of sensors, and determine identification information of the user associated with the device. The system may access profile information associated with the user, determine targeted interaction information based on the location information of the device and the profile information associated with the user, and provide the targeted interaction information for display to the user.

Some embodiments include a computer-implemented method for providing targeted interaction information to a user in an environment. The method includes receiving a communication from a client device associated with a user including a user identifier and a sensor identifier associated with at least one of a plurality of sensors positioned within the environment and determining, by one or more processors, an identity of the user and a location of the user within the environment based on the communication. The method also includes accessing profile information associated with the user, determining targeted interaction information for the user based on the identified location and the accessed profile information associated with the user, and providing the targeted interaction information for display to the user.

Aspects of the disclosed embodiments may include non-transitory computer-readable media that store a set of software instructions that, when executed by one or more processors, are configured to and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments. Moreover, aspects of the disclosed embodiments may be implemented on specialized (rather than generic) equipment or devices.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments.

FIG. 2 is a diagram of an exemplary sensor system, consistent with disclosed embodiments.

FIG. 3 is a block diagram of an exemplary computing system, consistent with disclosed embodiments.

FIG. 4 illustrates an exemplary environment, consistent with disclosed embodiments.

FIG. 5 illustrates an exemplary targeted interaction process, consistent with disclosed embodiments.

FIG. 6 is a diagram of an exemplary interface, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

While the following discussion is directed to services in a retail or merchant environment, discussion of these services and environments are made by example only. The systems and methods discussed herein may be just as applicable in other environments that may benefit from the ability to track a user or consumer's location and/or provide individualized services and notifications/information to the user.

Certain disclosed embodiments provide systems and methods for enabling individualized user interaction based on the sensing of a user's presence in a particular area of an environment. For example, certain disclosed embodiments may use a plurality of sensors, such as BLUETOOTH® low energy (“BLE”) beacons, beacon hubs, etc. in a merchant environment to determine a particular location of the user within the environment. In some embodiments, individualized services or information may be provided to the user based at least in part on the user's detected location. In some embodiments, the individualized services or information may also be based on profile information of a user accessible from one or more sources. The individualized services or information provided to the user may dynamically change based on changes in the user's detected location. In some embodiments, the services or information may be provided to the user in part via a client device, such as a smartphone, or other display or output in the merchant environment. In some embodiments, the user's interaction history with the environment may also form part of the user's profile information.

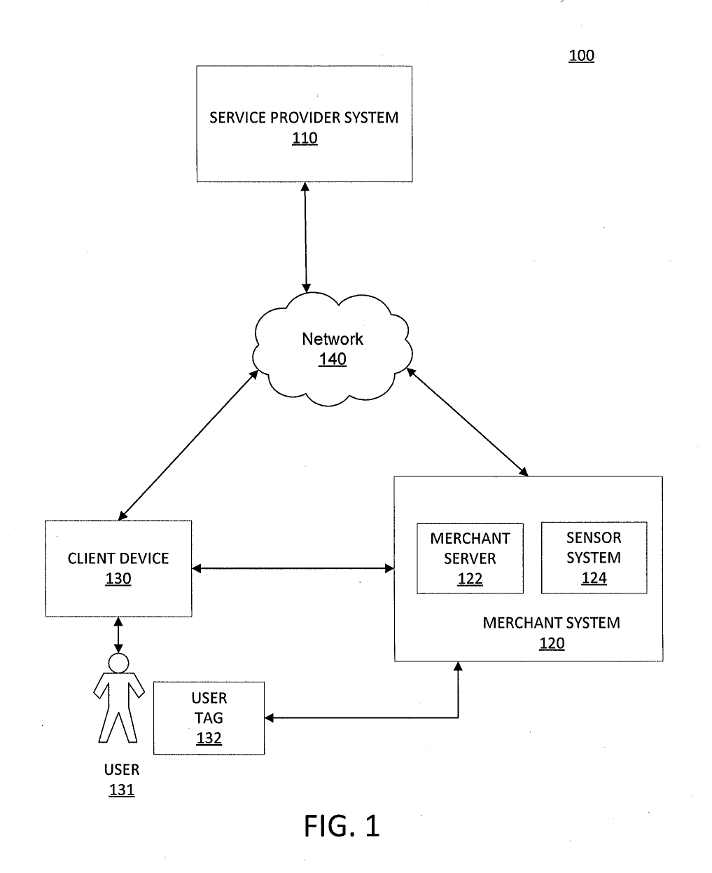

FIG. 1 is a block diagram of an exemplary system 100 for performing one or more operations consistent with the disclosed embodiments. In some embodiments, system 100 may include one or more service provider systems 110, one or more merchant systems 120, one or more client devices 130, one or more user tags 132, and network 140. The components and arrangement of the components included in system 100 may vary. Thus, system 100 may include other components that perform or assist in the performance of one or more processes consistent with the disclosed embodiments.

Components of system 100 may include one or more computing devices (e.g., computer(s), server(s), etc.), memory storing data and/or software instructions (e.g., database(s), memory devices, etc.), and other known computing components. In some embodiments, the one or more computing devices may be configured to execute software instructions stored on one or more memory devices to perform one or more operations consistent with the disclosed embodiments. Aspects of service provider system(s) 110, merchant system(s) 120, and client device 130 may be configured to communicate with one or more other components of system 100, via network 140, for example. In certain aspects, a user 131 may operate one or more components of system 100 to receive communications, initiate operations, and/or provide input for one or more operations consistent with the disclosed embodiments.

Components of system 100 may be configured to provide an enhanced user experience by providing individualized or targeted interaction information to user 131 as determined based on detection of the user's location in an environment and retrieval of certain profile information of the user relevant to the user's location. For example, in some embodiments, aspects of sensor system 124, provided as part of merchant system 120, may be configured to detect the proximity of a user within a merchant environment. Profile information of the detected user, stored by or accessible to merchant server 122, may be accessed to determine relevant targeted interaction information for output to the user based on the user's detected location. For example, as further described herein with respect to the merchant environment, targeted interaction information may be provided to the user based on a user's location such as at storefront entry, or a particular aisle or section of an aisle, or other location of the store such as the checkout area, etc. In some embodiments, targeted interaction information may include information regarding one or more products or services or other relevant information. The targeted interaction information may be based on profile information of user 131, which may be accessed by merchant system 120 from one or more sources, including a service provider system 110, such as a financial service entity. For example, in some embodiments, profile information may include transaction history or spending information, payment account information, loyalty program information or other related information stored by or accessible to service provider system 110.

Service provider system 110 may be a financial service entity that provides, maintains, manages, or otherwise offers financial services. For example, the financial service entity may be a bank, credit card issuer, or any other type of financial service entity that generates, provides, manages, and/or maintains financial service accounts for one or more users. Financial service accounts may include, for example, credit card accounts, loan accounts, checking accounts, savings accounts, reward or loyalty program accounts, and/or any other type of financial service account known to those skilled in the art. In providing, maintaining, managing or otherwise offering financial services, service provider system 110 may be enabled to authenticate financial transactions associated with a financial service account. Service provider system 110 may include infrastructure and components that are configured to generate and/or provide financial service accounts such as credit card accounts, checking accounts, debit card accounts, loyalty or reward programs, lines of credit, and the like.

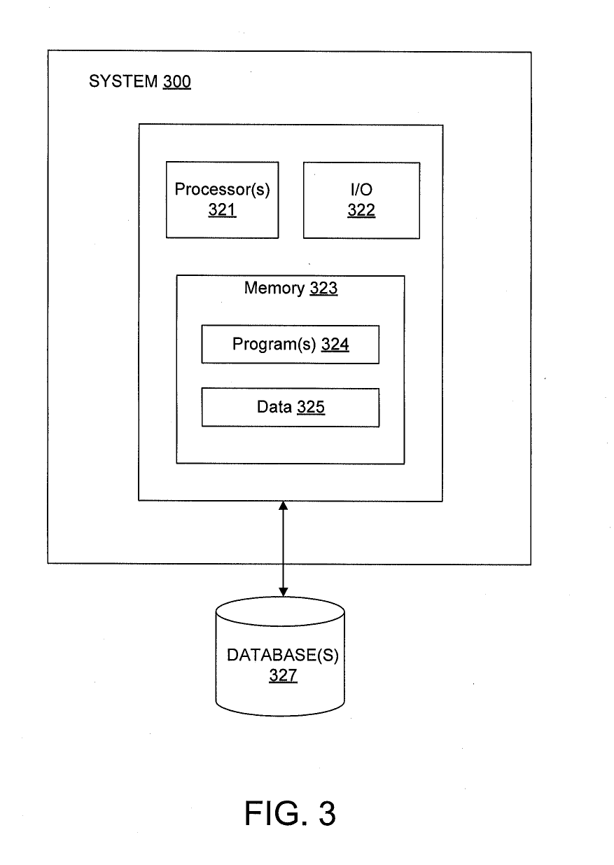

In one aspect, service provider system 110 may include one or more computing devices, such as that described below with respect to FIG. 3, configured to perform one or more operations consistent with disclosed embodiments. In one aspect, service provider system 110 may include one or more servers or server systems. Service provider system 110 may include one or more processors configured to execute software instructions stored in a memory or other storage device. The one or more processors may be configured to execute software instructions that, when executed by a processor, perform Internet-related communication, financial service-based processes, and authentication services for enabling consumer transactions. For instance, service provider system 110 may execute software that provides data used for generating and displaying interfaces, including content for a display device included in, or connected to, client device 130. In some embodiments, service provider system 110 may provide one or more web-sites or online portals that are accessible by client device 130 and/or merchant system 120 over network 140. The disclosed embodiments are not limited to any particular configuration of service provider system 110.

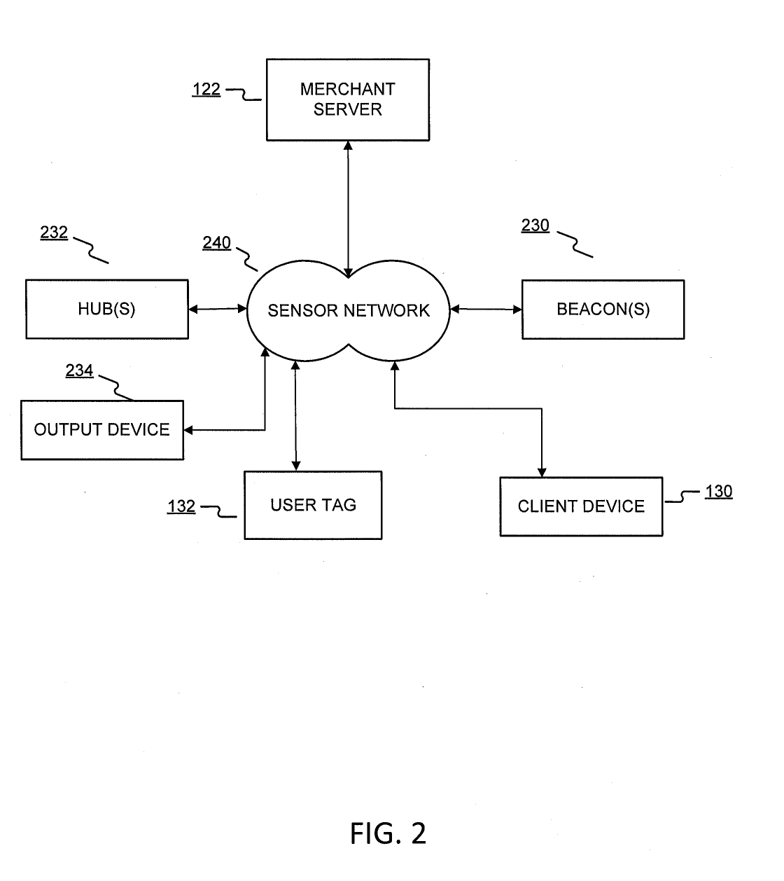

For purposes of illustrating the embodiments, merchant system 120 may be an entity that offers goods, services, and/or information, such as a retailer, grocery store, museum, or any other type of entity that offers goods and/or provides services. Merchant system 120 may also include a warehouse or factory or other entity including a plurality of items, products or other points of interaction that may benefit from the ability to track a location or presence of a user (such as an employee) within the environment. In one example, merchant system 120 may be associated with a merchant brick and mortar location(s) that a user (e.g., a user 131) may physically visit. Merchant system 120 may also include back- and/or front-end computing components, such as merchant server system 122, that store data and execute software instructions to perform operations consistent with the disclosed embodiments. Merchant server system 122 may include one or more computing systems configured to execute stored software instructions to perform operations associated with a merchant such as processing purchase transactions, generating transaction data, generating product data (e.g., SKU data) relating to purchase transactions, etc., as well as one or more processes associated with tracking and analyzing user locations in the merchant environment. Merchant system 120 may also include a sensor system 124. Sensor system 124, as described further herein with respect to FIG. 2, may include one or more sensors or beacons 230, one or more sensor or beacon hubs 232, one or more output devices 234 and a sensor network 240.

As further described herein, merchant system 120 may track the location of a user 131 (e.g., by tracking the location of user tag 132 carried by user 131 or based on information received from client device 130) and provide targeted interaction information based on the location of user 131. Merchant server 122, provided as part of merchant system 120, may be configured to access profile information of the user 131 and to provide user specific information to the user (e.g., by communicating with client device 130 or providing an output via a display or output device 234 within the merchant environment) based on the user's detected location. In some embodiments, profile information may correspond to user specific information accessible to merchant server 122, such as information associated with a merchant loyalty program or information derived based on the user's detected presence in the merchant environment. In some embodiments, information regarding a user's 131 location may be received, tracked, and analyzed by a merchant server 122 to update profile information of user 131 and to provide improved targeted interaction information to user 131 or other users. Profile information may also be retrieved from service provider system 110, which may be associated with the merchant's loyalty program or may provide a merchant branded financial service account, for example. In other embodiments, profile information may be retrieved from one or more other sources, such as a web-server storing social network profile information, or other third-party servers or systems.

Client device 130 may be one or more computing devices configured to perform one or more operations consistent with the disclosed embodiments. In some embodiments, client device 130 may be a mobile device (e.g., tablet, smart phone, multifunctional watch, pair of multifunctional glasses, etc.). Client device 130 may include one or more processors configured to execute software instructions stored in memory, such as memory included in client device 130. Client device 130 may include software that when executed by a processor performs known Internet-related communication, content display processes, and financial service-related processes for a user of client device 130. For instance, client device 130 may execute browser or related mobile display software that generates and displays interfaces including content on a display device included in, or in communication with, client device 130. Client device 130 may be a mobile device that executes mobile device applications and/or mobile device communication software that allows client device 130 to communicate with a service provider system 110 or merchant system 120 and other components over network 140, and generates and displays content in interfaces via a display device included in client device 130. Client device 130 may also store and execute other mobile applications that provide functions related to a merchant experience, such as by providing product information or assistance or other information related to a user's experience with merchant system 120, based in part on a user's detected location within a merchant system environment. Client device 130 may also include one or more hardware components and associated software to enable uni- or bi-directional communication with one or more sensors (beacons 230 and/or hubs 232) of sensor system 124. The disclosed embodiments are not limited to any particular configuration of client device 130.

In some aspects, as shown with respect to FIG. 2, client device 130 may include one or more hardware components and related software, which may enable client device 130 to communicate with sensors or beacons 230 and/or hubs 232 via sensor network 240. In some embodiments, client device 130 may communicate with beacon 230 or hub 232 via one or more receivers, transmitters or transceivers provided as part of client device 130. Client device 130 may also have an application installed thereon for providing certain information or services based on communication with beacons 230 or hubs 232. For instance, client device 130 may be a mobile device that activates or executes an application for presenting targeted interaction information to user 131 when user 131 interacts with sensor system 124 of a merchant environment.

In some embodiments, client device 130 may activate an application upon detecting a communication from a beacon 230 or hub 232 via one or more receivers provided as part of client device 130. In some embodiments, the application may be activated immediately upon entering the merchant environment, as may be determined based on communication with beacon 230 or hub 232 positioned near an entry-way of the merchant environment. In some embodiments, hub 232 may detect the presence of a client device 130 within the merchant environment by detecting a communication signal (e.g., cellular or other short-range wireless signal) of the client device and subsequently cause a communication from beacon 230 or hub 232 to be sent to the client device. In some embodiments, client device 130 may be configured to communicate with merchant server 122 to provide location based information and/or receive targeted interaction information. Client device 130 may connect to merchant server 122 through an application programming interface or through use of browser software stored and executed by client device 130. Client device 130 may be configured to execute software instructions that allow client device 130 to transmit and receive information to and from merchant server 122, such as, for example, user identification information, device information, user profile information, and the like. Additionally, client device 130 may be configured to execute software instructions that initiate and interact with one or more items in a merchant environment, such as, for example, to facilitate purchase transactions or barcode scans of retail sales products. An exemplary computer system consistent with user device 130 is discussed in additional detail with respect to FIG. 3.

User tag 132 may include one or more components configured to communicate with sensor system 124 to aid in the detection of a user's 131 location. In some embodiments, user tag 132 may be associated with unique user identifiable information, such that detection of user tag 132 may correspond to detection of user 131. User tag 132 may be embodied in a form suitable for carrying or wearing on user's 131 person, such as a key fob, smartcard, button, other wearable device etc. User tag 132 may be any device configured to communicate with one or more beacons 230 or hubs 232 of the disclosed embodiments. In some embodiments, user tag 132 may be incorporated as part of client device 130.

In some embodiments, user tag 132 may include certain components and circuitry or other technology to allow merchant hub(s) 232 to receive information from and track the location of the user tag 132 within a merchant environment, including technology associated with using, for example, BLUETOOTH® low energy (“BLE”), near field communication (NFC), RFID, infrared, electric fields, magnetic fields, Wi-Fi™, ZigBee®, etc. In general, user tag 132 may be configured to communicate user identifiable information according to a short range communication protocol suitable for enabling a determination of a location of user tag 132 within a controlled environment. User tag 132 may be an active device with an integrated power supply, or may be a passive, low-power device having no internal power source. In other embodiments, user tag 132 may be configured to receive communications from a beacon 230 and transmit, directly or indirectly, certain information to merchant server 122.

In some embodiments, network 140 may facilitate communications between merchant system 120, service provider system 110 and/or client device 130 to perform aspects of the disclosed embodiments. Network 140 may be any type of network configured to provide communications and the exchange of data between components of system 100. For example, network 140 may be any type of network (including infrastructure) that provides communications, exchanges information, and/or facilitates the exchange of information, such as the Internet, a private data network, a virtual private network using a public network, a Wi-Fi™ network, a LAN or WAN network, and/or other suitable connections that may enable information exchange among various components of the system 100. Network 140 may also include a public switched telephone network (“PSTN”) and/or a wireless cellular network. Network 140 may be a secured network or unsecured network. In other embodiments, one or more components of system 100 may communicate directly through a dedicated communication link(s).

It is to be understood that the configuration and boundaries of the functional building blocks of system 100 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

FIG. 2 shows an exemplary network architecture including aspects of sensor system 124, provided as part of merchant system 120 consistent with disclosed embodiments. For example, sensor system 124 may include one or more sensors, such as beacons 230 and hubs 232, one or more output devices 234, and a sensor network 240. In general, the components of sensor system 124 may be configured to enable merchant system 120 to detect and track the location of a user 131 within the merchant environment. In some embodiments, the location of user 131 may be determined based on communications between client device 130 and beacon 230. In another embodiment, the location of user 131 may be determined based on communications between user tag 132 and hub 232. In some embodiments, both a client device 130 and user tag 132 may be implemented to aid in the determination of a user's location. Communications between client device 130 and user tag 132 with other components of sensor system 124 may be facilitated by sensor network 240, which may comprise one or more near field communication (NFC), RFID, infrared, electric fields, magnetic fields, Wi-Fi™, BLUETOOTH®, or any other suitable wireless technology for performing operations consistent with disclosed embodiments. Sensor network 240 may also enable communications between merchant server 122 and other components of sensor system 124 including client device 130.

In certain embodiments, beacons 230 may include BLUETOOTH® low energy (“BLE”) beacons or other similar short-range type uni- or bi-directional communication devices. In some embodiments, BLE beacons 230 may sense the presence of a client device 130 being carried by user 131 within a merchant environment and transmit a communication signal to client device 130. In some embodiments, beacons 230 may periodically transmit a communication signal to any client device within range. Other candidate sensing technologies may include, without limitation, cellular (e.g., 3G, 4G, etc.) technology, Wi-Fi™ hotspot technology, near-field communication (“NFC”), other BLUETOOTH® technologies, and/or other wireless communication technologies and protocols. This disclosure contemplates that any uni- or bi-directional communication technology known to one of ordinary skill in the art may be utilized by the beacons 230 to determine a user's location and/or exchange information with the client device 130. Client device 130, in turn, may be configured to communicate according to the selected communication technology.

In certain embodiments, client device 130 may execute a software application to facilitate detection of the client device by one or more beacons 230, as well as to detect communication from beacons 230. In some embodiments, the software application may be an application provided by a merchant associated with merchant system 120. In other embodiments, the application may be associated with both merchant system 120 and service provider system 110. In some embodiments, client device 130 may be configured to receive a communication signal from beacon 230 and extract identification information received from the beacon 230. The identification information received from the beacon 230 may enable the application operating on client device 130 to determine the location of client device 130. In some embodiments, client device 130 may transmit the identification information received from the beacon 230 to merchant server 122 provided as part of merchant system 120, which may then be able to determine the location of client device 130. For example, client device 130 may transmit the beacon identification information to merchant server 122, and based on the beacon identification information, merchant server 122 may be able to determine the location of client device 130. That is, the beacon identification information received by client device 130 may only be received within a short range from the beacon 230 whose precise location within the merchant environment may be known. Other signal information, such as received power or signal strength of the communication received from beacon 230 may be used to facilitate the determination of a precise location of client device 130. Client device 130 may be configured to communicate with merchant server 122 over sensor network 240 or network 140, shown in FIG. 1.

In certain disclosed embodiments, the use of BLE beacons or other technologies may eliminate the need for running a merchant application, or indeed any software application, on client device 130 to facilitate tracking user 131 in the merchant environment. In such scenarios, a pure-hardware solution may be implemented on client device 130 to facilitate signal communication between client device 130 and beacon 230, so that beacon 230 may detect the presence of the client device 130 and/or exchange information with the client device 130.

In other embodiments, client device 130 may be configured to communicate a signal including identification information to beacon hub 232, which may in-turn provide such information to merchant server 122. Beacon hub 232 may include a transceiver or transmitter configured to communicate using one or more wireless technologies/protocols that may include, without limitation, cellular (e.g., 3G, 4G, etc.) technology, Wi-Fi™ hotspot technology, near-field communication (“NFC”), other BLUETOOTH® technologies, etc. This disclosure contemplates that any uni- or bi-directional communication technology known to one of ordinary skill in the art may be used by hubs 232 to determine a user's location and/or exchange information with the client device 130, user tag 132, and merchant server 122. In some embodiments, hubs 232 may be configured to communicate with merchant server 122 using any technology of network 140, including Ethernet or other wired or longer-range technologies enabled by network 140. Similar to the above, merchant server 122 may be able to determine a location of client device 130 based on communication received from hub 232. In general, a location of client device 130, and thus location of user 131, within a merchant environment may be determined based on communications with one or more beacons 230 or hubs 232 whose precise location is known.

Throughout the disclosure, beacon 230 may generally correspond to a transmitting device that transmits a communication signal including information that may be used by client device 130 to enable client device 130 or merchant server 122 to determine a location of client device 130 relative to beacon 230 in the merchant environment. In some embodiments, beacon 230 may be configured to receive limited communications from client device 130, such as a ping signal. Beacons 230 may also be configured to receive and/or transmit limited communication with merchant server 122, such as to receive updates or other information. In some embodiments, beacon 230 is configured as a low-power or passive device with a limited footprint.

Throughout the disclosure, beacon hub 232 may generally correspond to a transceiver device that may receive communications from client device 130 or user tag 132 and may include capability to communicate with merchant server 122 via sensor network 240 or network 140. Beacon hub 232 may also be configured to provide targeted interaction information to client device 130 via sensor network 240 or network 140. In some embodiments, the functionality of beacon 230 and beacon hub 232 can be combined as an integrated device.

In another embodiment, location of user 131 may be determined based on communications between user tag 132, worn or carried by user 131 and one or more hubs 232. Hubs 232 may be configured to emit communication signals to communicate with and/or activate user tag 132, which may then respond with a communication signal including identifiable information of user 131. Hubs 232 may also be configured to receive the communication from a user tag 132 (or client device 130). In response to a communication received from user tag 132 or client device 130, hub 232 may forward the communication to merchant server 122 with additional information identifying hub 232 as the sender. Merchant server 122 may then determine a location of user 131 based on the received communication, as similarly described above. In some embodiments, merchant server 122 may communicate targeted interaction information to hub 232 to be provided to user 131 via client device 130 or output device 234. In other embodiments, hub 232 may be configured to identify user 131 and provide targeted interaction information to user 131 via communication with client device 130 or output device 234.

Output device 234 may include any output device capable of providing targeted interaction information to user 131. For example, in some embodiments, output device 234 includes any type of display device capable of providing visual indication of targeted interaction information to user 131. Exemplary display devices may include an LED, LCD, Plasma or other television or monitor type device, as well as a projector or other system for projecting visual information. Output device 234 may be communicatively connected with hubs 232 or merchant server 122 for receiving targeted interaction information for output or display to user 131. Output device 234 may correspond to one of a plurality of displays provided throughout an environment for providing targeted interaction information to user 131 located in the vicinity of the display. In other embodiments, output device 234 may correspond to a speaker or other device for providing audio output capable of being heard by user 131. In some embodiments, output device 234 may correspond to an output device provided as part of or in communication with client device 130.

One or more of the components of system 100 and sensor system 124 may include specially purposed computing systems programmed to provide the desired functionality. Certain general or common aspects of these computing systems are described with respect to FIG. 3, which shows an exemplary computing system 300 consistent with disclosed embodiments. Variations of exemplary computing system 300 may constitute one or more components of service provider system 110, merchant system 120 (such as merchant server 122, sensor system 124, etc.), and/or client device 130. In one embodiment, system 300 may comprise one or more processors 321, one or more input/output (I/O) devices 322, and one or more memories 323. In some embodiments, system 300 may take the form of a specially programmed server or computing system. In some embodiments, system 300 may take the form of a mobile computing device (e.g., client device 130) such as a smartphone, tablet, laptop computer, pair of multifunctional glasses, or any combination of these components. In other embodiments, system 300 may take the form of other specially purposed computing devices, such as a hub 232, output device 234, etc. In some embodiments, system 300 may be configured as an apparatus, embedded system, dedicated circuit, and the like based on the storage, execution, and/or implementation of the software instructions that perform one or more operations consistent with the disclosed embodiments.

Processor 321 may include one or more known processing devices, such as a microprocessor from the Pentium™ or Xeon™ family manufactured by Intel™, the Turion™ family manufactured by AMD™, or any of various processors manufactured by Sun Microsystems, for example. The disclosed embodiments are not limited to any type of processor(s) otherwise configured to meet the computing demands required of different components of system 100. For example, processor 321 may also include one or more mobile device microprocessors when a variation of system 300 is client device 130.

Memory 323 may include one or more storage devices configured to store instructions used by processor 321 to perform functions related to disclosed embodiments. For example, memory 323 may be configured with one or more software instructions, such as program(s) 324 that may perform one or more operations when executed by processor 321. The disclosed embodiments are not limited to separate programs or computers configured to perform dedicated tasks. For example, memory 323 may include a single program 324 that performs the functions of system 300, or program 324 may comprise multiple programs. In certain embodiments, memory 323 may store sets of instructions or programs 324 for analyzing a user's 131 presence and interaction in an environment and providing real-time targeted interaction information based on the user's location and profile information. These sets of instructions may be executed by processor(s) 321 to perform one or more communication and/or analysis processes consistent with disclosed embodiments. Memory 323 may also store data 325 that is used by one or more programs 324 consistent with the disclosed embodiments. In some embodiments, data 325 may include a plurality of user profile information, as well as data corresponding to targeted interaction information, as detailed below.

I/O devices 322 may be one or more devices configured to allow data to be received and/or transmitted by system 300. I/O devices 322 may include one or more digital and/or analog devices that allow system 300 to communicate with and/or detect other machines and devices, such as other components of system 100. For example, when system 300 is implemented as service provider system 110 or merchant system 120, I/O devices 322 may include a network controller, a wired network adapter, a wireless network adapter, a cellular network adapter, or the like for communicating over network 140. In some embodiments, I/O devices 322 may include a screen for displaying an interface. I/O devices 322 may also include one or more digital and/or analog devices that allow a user to interact with system 300 such as a touch-sensitive area, keyboard, buttons, or microphones. I/O devices 322 may also include other components known in the art for interacting with a user.

The components of system 300 may be implemented in hardware, software, or a combination of both hardware and software, as will be apparent to those skilled in the art. For example, although one or more components of system 300 may be implemented as computer processing instructions, all or a portion of the functionality of system 300 may be implemented instead in dedicated electronics hardware.

System 300 may also be communicatively connected to one or more database(s) 327. In one aspect, system 300 may include database 327. Alternatively, database 327 may be located remotely from the system 300. System 300 may be communicatively connected to database(s) 327 through network 140. Database 327 may include one or more memory devices that store information and are accessed and/or managed through system 300. By way of example, database(s) 327 may include Oracle™ databases, Sybase™ databases, or other relational databases or non-relational databases, such as Hadoop sequence files, HBase, or Cassandra. The databases or other files may include, for example, data and information related to targeted interaction data, user interaction history or other profile information, purchase transaction data, etc. Database 327 may include computing components (e.g., database management system, database server, etc.) configured to receive and process requests for data stored in memory devices of database(s) 327 and to provide data from database 327.

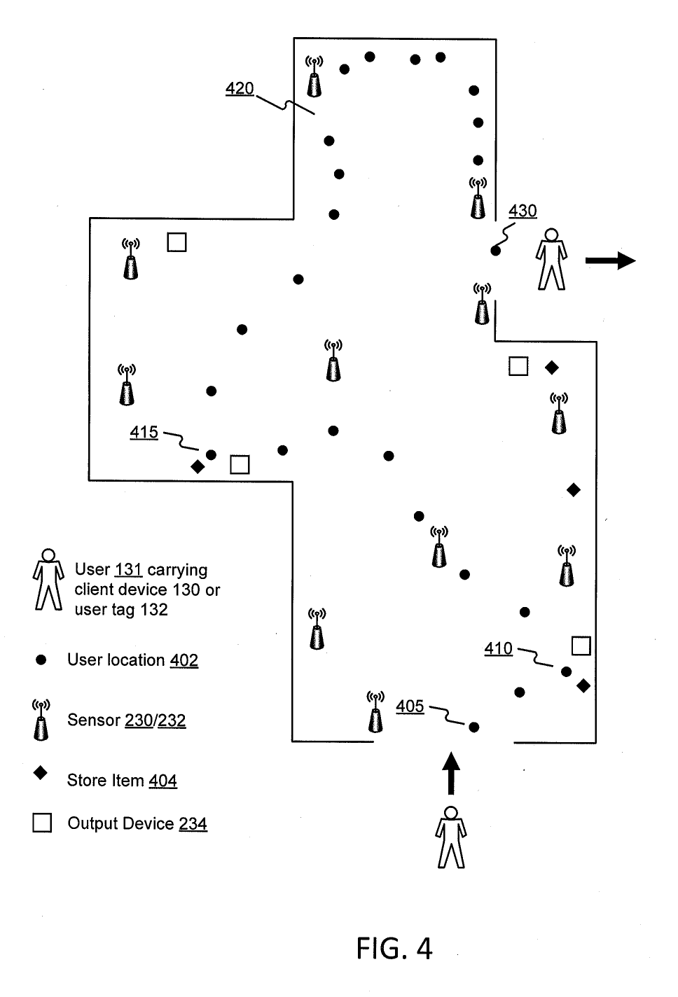

FIG. 4 illustrates an exemplary environment, such as a merchant environment, including aspects of sensor system 124, consistent with disclosed embodiments. Consistent with disclosed embodiments, one or more sensors, such as beacons 230 or hubs 232, may be positioned throughout the environment in a plurality of locations to determine a user's location 402 and movement throughout the environment, as well as interaction with one or more items 404 positioned throughout the environment. The number of sensors and placement of sensors may vary based on the size or layout of the environment, as well as the nature of the intended targeted information. In the disclosed embodiments, communication, via client device 130 or user tag 132, with a sensor (beacon 230 or hub 232) enables sensor system 124 to determine a location of user 131 within the environment. Based in part on the user's determined location, merchant system 120 may determine to provide targeted interaction information and the type of information to provide. Thus, for example, in some embodiments, a single sensor may be provided for each of a plurality of distinct regions or areas of the environment for which merchant system 120 may desire to provide targeted information, such as information relevant to the user's determined location (e.g., user ratings, current offers, and the like associated with one or more products within a predetermined range of the user's determined location). In other embodiments, a plurality of sensors may be provided in each of a plurality of distinct areas, thus enabling merchant system to provide information regarding a product or in-store display provided within the area. In some embodiments, sensors may be placed throughout the merchant environment to track a user's location without particular consideration of providing targeted information. Further, in some embodiments, a sensor may be provided on a product or a plurality of products that may be moved throughout the merchant environment, thereby associating user 131 with the product instead of any particular location within the merchant environment.

In an exemplary embodiment set in a merchant environment, sensors 230/232 may be provided throughout the environment as shown in FIG. 4 to track a user's 131 presence and movement throughout the store. For example, a first sensor, or plurality of sensors, may be provided near the entrance of the merchant environment to detect that user 131 has entered the environment (event 405). As detailed above with respect to FIG. 2, user 131 may be detected at the entrance based on communication between client device 130 and beacon 230, user tag 132 and hub 232, or a combination of both. One of client device 130 or hub 232 may be configured to communicate the user's location to merchant server 122 based on the communication. For example, client device 130 may be configured to communicate information received from a beacon 230 to merchant server 122 via network 140, for example. The information received from beacon 230 may include identifying information associated with the particular beacon whose location is known to merchant server 122. Based on the identifying information, merchant server 122 may determine that user 131 is located in the vicinity of beacon 230. In other embodiments, a hub 232 may receive identifying information particular to user 131 in a communication received from client device 130 or user tag 132. Hub 232 may be configured to identify the user 131 based on the communication and communicate the user's presence to merchant server 122. Merchant server 122 may determine that user 131 is located in the vicinity of hub 232 based on the communication received from hub 232.

Upon identifying the user 131 and the user's location, merchant server 122 may then store and analyze the information associated with the user's location to determine whether to provide targeted interaction information to user 131. In some embodiments, merchant server 122 may determine whether to provide targeted interaction information via client device 130 or output device 234, for example. In some embodiments, merchant server 122 may access profile information of user 131 to determine the targeted interaction information to provide to the user. Merchant server 122 may also store detailed information associated with the detection of the user's presence for building profile information of user 131, which may be used to determine targeted interaction information for user 131 on the current visit or subsequent visits to the merchant environment or other associated merchant environments.

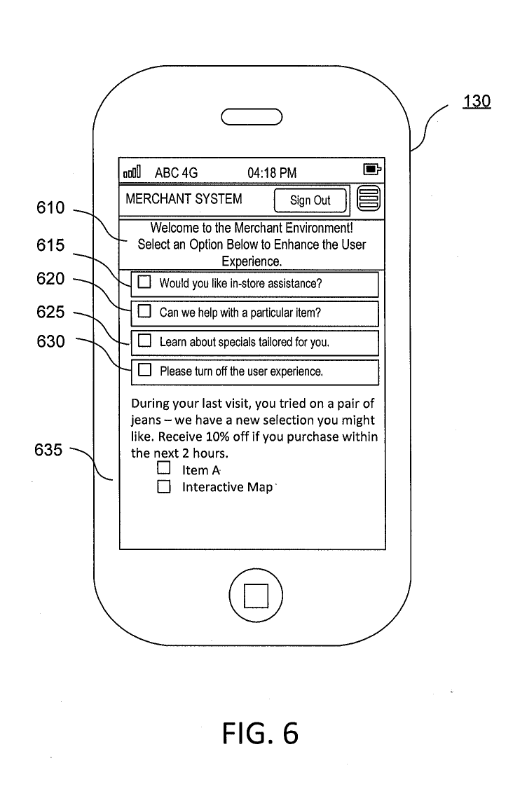

In some embodiments, upon communication with a sensor 230/232 near an entryway of the merchant environment, an application executed on client device 130 may automatically activate and generate an interface, such as that shown in FIG. 6, for initiating an interactive experience with user 131. The application may activate upon receipt and recognition of a signal from a sensor 230/232 for initiating the interactive experience. In other embodiments, user 131 may activate an application prior to or upon entering the merchant environment. In some embodiments, the application may direct client device 130 to communicate with merchant server 122 at predetermined intervals or upon receipt of a signal from beacon 230 or hub 232, for example. Such communication may function to update merchant server 122 regarding the location and movement of client device 130 throughout the merchant environment.

In the disclosed embodiments, sensor system 124 may detect the presence of user 131 in other areas of the merchant environment, which may also correspond to the vicinity of a particular item. For example, merchant system 120 may be able to determine a user's interaction with a particular item in the environment, such as event 410 and 415. Upon receiving an indication of the user's presence in the area, merchant server 122 may determine (based at least in part on the user's profile information) whether and what targeted interaction information to provide to user 131. In some embodiments, a user's presence or interaction in the area of event 410 subsequently followed by the user's presence or interaction in area 415 may trigger the determination of one or more targeted interaction information. As such, targeted interaction information may be dynamically determined based on the user's current interactions with the environment, as well as other profile information corresponding to user 131.

In some embodiments, merchant server 122 may be able to determine the duration of the user's presence in the area based on a plurality of communications associated with client device 130 and a particular beacon 230, customer tag 132 and a particular hub 232, or a combination of both. For example, each of beacon 230, hub 232, client device 130 and user tag 132, depending on the implementation, may be programmed to emit a communication signal or listen for a communication signal at a predetermined frequency, such as every 500 ms, for example. Where multiple communications are received by client device 130 or hub 232 over time, the duration of a user's presence can be determined. Merchant system 122 may determine to provide certain targeted interaction information when a user's duration at a particular location exceeds a predetermined threshold. In some embodiments, the threshold may alternatively be dynamically determined based on a user's profile information, the user's location within the environment, products within the user's vicinity, etc. Additionally, merchant server 122 may determine that the user's locations corresponding to events 410 and 415 are near an output device 234. Merchant server 122 may then determine whether to provide targeted interaction information via an output device 234 based on the detected presence of user 131.

In some embodiments, merchant server 122 may receive updating communications from client device 130 or hubs 232, from which a pattern of user movement throughout the environment may be determined. The user's pattern of movement may form part of the user's profile information, which may be used by merchant server 122 to provide targeted interaction information to user 131 as the user moves throughout the merchant environment. Specific detailed examples of certain targeted interaction information is provided below. As shown in FIG. 4, merchant server 122 may also be able to determine when a user 131 enters an area designated as a checkout area, such as event 420, or an exit area associated with event 430. In some embodiments, determination of events 420 and 430 may correspond to one or more “phases” of a user experience for which certain targeted interaction information may be determined for output to user 131. For example, determination of events 420 and 430 may trigger determination of certain targeted interaction information associated with those areas or phases, as discussed in greater detail below.

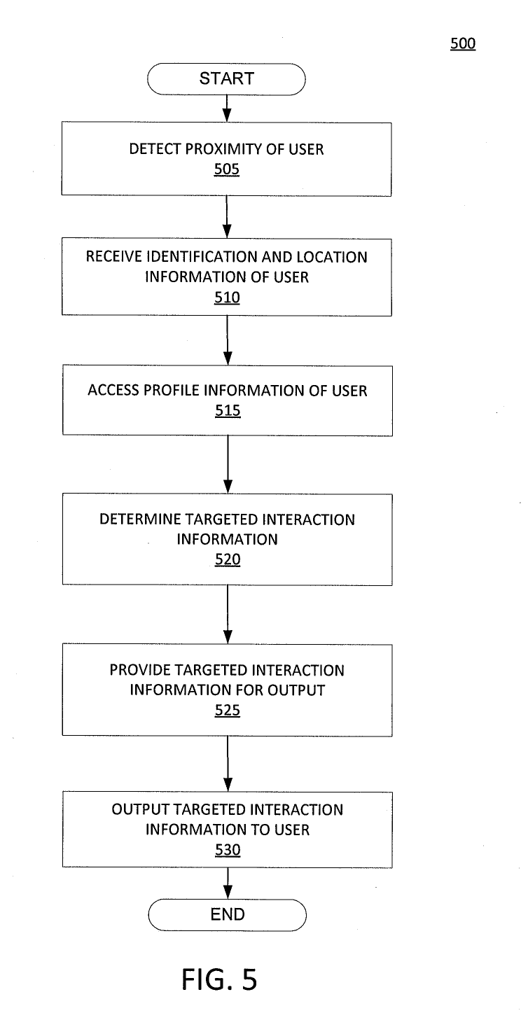

FIG. 5 shows a flowchart of an exemplary process 500 for providing targeted interaction information to a user 131, consistent with the disclosed embodiments. According to some embodiments, process 500 may be employed within a retail or merchant environment. In some embodiments, the operations of process 500 may be performed continuously as merchant system 120 and sensor system 124 detect the presence of a user 131 and the user's movement throughout the merchant environment. The following process may also be implemented in a factory or warehouse setting or other environment for which it may be beneficial to determine location information of a user and provide targeted interaction information to the user.

In step 505, merchant system 120 implementing sensor system 124, may identify a user's 131 presence in the particular merchant environment, such as a brick-and-mortar store, for example. As similarly discussed above with respect to FIG. 4, step 505 may first be initiated as user 131 enters the merchant environment. For example, sensor system 124 may be configured such that one or more beacons 230 or hubs 232 are positioned near a point of entry to the merchant environment or other area or region of the environment. Additionally, sensor system 124 may determine the proximity of user 131 to one or more sensors such as beacon 230 or hub 232.

In step 510, aspects of merchant system 120, such as merchant server 122, may receive identification and location information of user 131, similar to that described above with respect to FIG. 4. For example, in some embodiments, merchant server 122 may receive a communication from a client device 130 associated with a user 131 including identification information particular to client device 130 or user 131. Merchant server 122 may also receive information associated with a beacon 230 or hub 232, from which merchant server 122 may determine the location of user 131. In other embodiments, merchant server 122 may receive communication from hub 232 including identification information associated with user 131 from which merchant server 122 may determine the location of user 131. In some embodiments, merchant server 122 may store and/or analyze the determined location information of user 131 and update profile information of user 131 accordingly.

In step 515, merchant server 122 may access profile information associated with user 131. In the disclosed embodiments, profile information may correspond to any information associated with user 131 that may be relevant for providing targeted interaction information to user 131. The nature of profile information may vary between embodiments based on the intended content or nature of targeted interaction information. In some embodiments, profile information may include history of a user's interaction with the environment as detected by sensor system 124 and analyzed by merchant system 120. Profile information may include a user's prior interaction history within the environment, as well as location and interaction information related to the current interaction within the environment. In other embodiments, profile information may include purchase or transaction history information associated with user 131, such as may be received from service provider system 110. Purchase or transaction history information may include detailed information regarding a user's purchases and purchasing habits or tendencies. In other embodiments, profile information may include information received from user 131 regarding the user's interests or preferences. In some embodiments, profile information may include information gathered from one or more third party sources, such as social networking profile or activity information, including information based on social networking posts, messages, etc. that user 131 created, commented on, or otherwise interacted with. Other sources of profile information may include a web server storing a user's web-browsing history and other Internet activity. Profile information may include raw information received from one or more sources, as well as information determined based on the received raw information. Thus, in some embodiments, aspects of merchant system 120, such as merchant server 122, may be configured to analyze the information from one or more sources to determine relevant profile information of user 131 and determine analytics or other metrics based on the relevant profile information. In some embodiments, profile information of user 131 may also be determined based on information corresponding to one or more other users that have been identified as having similar needs, preferences, and/or habits, etc.

In some embodiments, profile information of user 131 may be analyzed and categorized according to its relevance to one or more types of targeted interaction information. For example, to facilitate identification and retrieval of relevant profile information for determining targeted interaction information, profile information may be indexed or categorized according to one or more indices related to targeted interaction information. For example, certain profile information may be relevant for determining targeted interaction information when a user 131 first enters a merchant environment, such as information related to the last visit of the user to the environment or other information related to a product or service that merchant server 122 may determine the user 131 is due to purchase soon. Other profile information may be relevant while a user 131 is browsing or moving throughout the environment, such as information concerning certain items previously purchased, or other complementary items, as well as other tendencies to help enhance the current experience, for example. And still other profile information may be relevant when user 131 is in a checkout area or is leaving the merchant environment, such as the availability of rewards or rebates, or the applicability of using a particular financial account for making a payment, other items that user 131 may have forgotten, etc. Various aspects of the profile information may overlap in some examples, and the above examples are not meant to be limiting. The profile information relevant for one or more environment locations or interaction phases may be grouped or indexed as such to enhance the speed at which relevant targeted interaction information may be determined.

In step 520, merchant system 120 or merchant server 122 may determine, in real-time, targeted interaction information for presenting to user 131. In some embodiments, targeted interaction information may be determined based on both the profile information of user 131, as well as the current location information of user 131 within the environment. In some embodiments, targeted interaction information may be determined based on one or more relational models of profile and location information. For example, merchant server 122 may first determine a category of targeted interaction information based on the detected location of user 131. From this category of targeted interaction information, merchant server 122 may then determine particular targeted interaction information based on the user's profile information. In some embodiments, targeted interaction information may be dynamically generated based on changes in a user's location or current interaction within the environment. In some embodiments, targeted interaction information may also be based on current inventory levels of products or the availability of services, or other changes in aspects of an environment, such as user congestion, or delays in a checkout line, etc.

Targeted interaction information may also be determined based on the nature of the output device. Thus, as part of step 520, merchant server 122 may determine whether the targeted interaction information is to be provided to a client device 130 associated with user 131, or an output device 234 provided within the environment, and determine the targeted interaction information suitable for providing to the user via one of the devices. In some embodiments, merchant server 122 may determine whether an output device 234 is within a predetermined range of user 131 when determining whether to output targeted interaction information via a client device 130 or output device 234. In some embodiments, merchant server 122 may also determine whether to output targeted interaction information to output device 234 based on the detected presence of other users in the vicinity of output device 234. Thus, for example, merchant server 122 may forgo providing targeted interaction information to an output device 234 when one or more other users are present. Furthermore, in some embodiments targeted interaction information presented to an output device 234 may be based on common profile information of a plurality of users in the vicinity of the output device 234.

In the disclosed embodiments, targeted interaction information may correspond to any information merchant system 120 or merchant server 122 determines is relevant to user 131 based on the user's location and profile information. For example, in a retail environment, targeted interaction information may correspond to information regarding a past purchase, such as the size or color of a previously purchased item, or an item related to a past purchase, such as a belt to match the shoes of a prior purchase, or other information to enhance the user's experience including information regarding sale items or other offers. Targeted interaction information may also correspond to detailed product information or other information to assist a user, including interactive map information or other information enabling user 131 to seek assistance from in-store personnel. In some embodiments, targeted interaction information may be interactive and may be capable of receiving user input associated with the targeted interaction information. Other examples of targeted interaction information are provided in the detailed examples below.

In step 525, merchant server 122 may provide the determined targeted interaction information for output to user 131. In some embodiments, the targeted interaction information may be output to a client device 130 or an output device 234. As part of step 525, merchant server 122 may configure the targeted interaction information for suitable output to the user 131, such as providing information and/or instructions for generating an interface via a display of client device 130 or other output device 234. The targeted interaction information may be configured to take advantage of the capabilities of client device 130 or output device 234. For example, targeted interaction information may be configured differently for output on a relatively larger output device 234 than would be for output on client device 130. In other embodiments, merchant server 122 may configure the targeted interaction information to be output via a speaker or any other device for providing information. In step 530, the targeted interaction information may be output to user 131 via client device 130 or output device 134 as provided and/or instructed by merchant server 122.

Process 500 is further illustrated in the context of concrete examples below. The following examples are meant to be illustrative of certain functionality and capabilities of the disclosed systems and methods, and are not exhaustive of all envisioned implementations of the disclosed systems and methods. While the following examples are specific to a merchant or retail environment, the disclosed systems and methods may be adapted for any suitable environment for providing targeted interaction information to a user based on the user's location and profile information. The nature and content of the targeted interaction information may thus be modified according to the particular environment.

In a retail merchant environment, targeted interaction information may be provided based in part on the user's interaction “phase” based on interactions associated with the current visit. As discussed above, such information regarding a current visit may be included as profile information for enabling merchant server 122 to determine suitable targeted interaction information for output to user 131. A first interaction phase associated with the current visit may be considered a “greetings phase,” which may begin when the presence of user 131 is first detected at the merchant site, such as described with respect to event 405 in FIG. 4 above and step 505 in FIG. 5. In some embodiments, upon entering the merchant environment, and receiving communication from beacon 230 or hub 232, client device 130 may automatically initiate an application stored on client device 130 for providing aspects of the disclosed embodiments. The application may initially provide an interface greeting the user and providing a plurality of options that enable user selection for tailoring certain functionality of the application. For example, as shown in FIG. 6, an exemplary interface displayed on client device 130 may include a plurality of windows providing targeted interaction information or other selectable options. As shown, a first window 610 may provide the initial greeting to user 131 upon initiation of the application. A number of options may also be displayed to enable selection of a level of interaction with the application for this particular visit. As such, the interface may enable selection to track the user's location or to turn off tracking, such as via selection of window 630. Additionally, the interface may enable selection of one or more goals or needs of the user for this particular visit. For example, the interface may enable user selection to immediately request in-store assistance (via window 615), or alternatively, the interface may enable selection of one or more products that user 131 is interested in or other information that user 131 desires (via window 620). The application may also provide a selection to learn about relevant special offers (via window 625).

Additionally, an exemplary interface may provide a window 635 for providing targeted interaction information to the user. In the example shown, merchant server 122 has determined based on the user's prior interaction retrieved from the user's profile information, that the user may be interested in a new selection of jeans. In some embodiments, the application may be configured to provide additional information concerning the product, a special time sensitive offer for the promoted product or an interactive map for directing the user to the relevant section of the environment, as well as other additional relevant information.

Upon initiation of the application, the application may automatically transmit a communication to merchant server 122 providing identification and location information, as described above. Upon receipt of the communication from client device 130, merchant server 122 may determine the identification and location information of the user (step 510). In some embodiments, merchant server 122 may also be able to determine a “phase” of the user's interaction with the environment, based on, for example, detection of a user's movement in the merchant environment or a particular location of the user in the environment. Merchant server may then access profile information of the user (step 515) to identify any information that may be relevant for providing targeted interaction information, based at least on the location of the user. As described above, merchant server 122 may access a subset of profile information categorized or indexed according to the detected location of user 131 or phase of interaction with the environment to facilitate the determination of relevant targeted interaction data.

Upon determining that user 131 just entered the merchant environment, merchant server 122 may provide targeted interaction information to user 131 including any promotional offers, special sales, new products or other information relevant for the current visit. In the disclosed embodiments, any information relevant to user 131 based on the user's profile information may be determined as the targeted interaction information. Thus, in some embodiments, information concerning the promotional offers, special sales, and new products, etc. that are provided to user 131 are determined particularly for user 131 based on the user's profile information. For example, profile information of user 131 may indicate that the user recently purchased a pair of jeans of a particular brand. Based on this information, merchant server 122 may determine that a sale on that brand of jeans is relevant information for the user. As such, merchant server 122 may present targeted interaction information to user 131 notifying the user of the sale on the brand of jeans. In another embodiment, profile information of user 131 may indicate that the user tends to purchase paper towels every other month. Based on this information, merchant server 122 may provide relevant targeted interaction information to user 131 indicating that it may be time to purchase paper towels again. Any promotional offers or deals may also be presented to user 131 at this time. Other targeted interaction information may also be provided to user 131 based on their prior transaction history, or purchasing trends. For example, where a user tends to purchase new products of a particular manufacturer or technology, certain targeted interaction information may be provided to direct the user to the new product offerings. In some embodiments, inventory information may be provided to the user indicating that only a limited number of products remain. Additionally, inventory information may be provided specific to user 131, such as a size of jeans that user 131 wears, indicating that jeans are still available in the user's preferred size.

In some embodiments, targeted interaction information may be dynamically generated by merchant server 122 based on a time of day or amount of inventory for an item. For example, the individualized, targeted nature of promotions and other offers enable merchant system 120 to more effectively promote certain goods or services to better control inventory. For example, special or increased offers may be targeted to users later in the day to help the merchant release a particular item from their inventory. In some embodiments, targeted interaction information may be updated to indicate the number of items remaining at a particular price. A number of other promotional sales techniques may be implemented using the disclosed systems and methods. In the disclosed embodiments, the promotional information may be provided in real-time, selectively to certain users. Moreover, the disclosed systems and methods are advantageous because the promotional offers are determined to be relevant to the particular targeted users. In some embodiments, merchant server 122 may be able to identify frequent or valuable users and selectively provide special offers to the user based on their loyalty to the merchant.

Additionally, merchant server 122 may be able to determine from a user's profile information that specialized assistance is needed for the user 131 and arrange for an in-store assistant to assist the user. The user 131 may be notified as targeted interaction information that assistance is coming and a time when the assistance may arrive. Additionally, assistance may be provided in a prompt manner based on the precise identification of the user's location, as described in detail above.

As another example, merchant server 122 may be able to determine from the user's profile information, that the user's current visit is the third such visit within a period of time. Merchant server 122 may also be able to determine from the profile information, the degree of interaction of the user on the previous visits, such as the duration of time spent in the environment, the areas visited within the environment, whether any items were purchased, etc. Based on this information, merchant server 122 may analyze such profile information to determine interaction information that may be relevant to user 131. For example, merchant server may provide targeted interaction information offering personalized assistance to user 131, where user 131 may not have purchased anything in the prior trips, or merchant server 122 may offer special discounts for the repeated purchases within the period of time, etc. In some embodiments, where repeat purchases are made by user 131, for example, merchant server 122 may determine targeted interaction information offering to automatically fulfill a purchase for the user 131. For example, merchant server 122 may provide targeted interaction information via an interface on client device 130 enabling selection to fulfill the purchase order and have the order ready for pick-up at a check-out area or other area of the merchant environment. In some embodiments, the transaction may be automatically fulfilled based on transaction account information stored as profile information in association with user 131.

Another interaction phase of the disclosed embodiments may include a “pre-purchase phase” corresponding to a phase of interaction as the user 131 moves throughout the merchant environment. Numerous types of targeted interaction information may be provided to the user based on a determination considering the user's current interaction, the user's previous interactions, other profile information, the merchant's inventory or other special merchant programs or offers, as well as other relevant information. Certain information discussed above with respect to the “greetings phase” may also be provided in the “pre-purchase phase” or other interaction phases. Indeed, in some embodiments, various targeted interaction information may overlap between interaction phases based on a user's profile information or based on a user's current interaction in the environment.

To provide a few non-exhaustive examples, in one embodiment, merchant server 122 may determine that a user 131 has remained in a particular location or area for an extended duration of time. In some embodiments, merchant server 122 may determine that user 131 also visited that area of the environment on a prior visit. Depending on the user's profile information and the current interaction information, merchant server 122 may determine to provide targeted interaction information asking user 131 if he/she needs specific assistance. Client device 130 may provide an interface enabling user selection for assistance, upon which merchant server 122 may notify an in-store assistant. Merchant server 122 may provide the user's location, as detected by sensor system 124, to the in-store assistant. In some embodiments, merchant server 122 may provide via a client device interface, for example, indication that in-store assistance will arrive within a certain period of time. Merchant server 122 may also provide, via the client device interface, an interactive map highlighting the assistant's location within the store. The assistant's location may be similarly tracked using the disclosed systems, such that user 131 can track the assistant's movement throughout the merchant environment as user 131 awaits help. In another embodiment, the in-store assistant may be provided with a client device, similar to the disclosed embodiments, on which an interactive map identifying the user's location may be displayed. The interface may also provide additional information to the in-store assistant based on the user's request for assistance and the user's profile information to enable the in-store assistant to provide improved service. In some embodiments, the user's client device 130 and a client device operated by an in-store assistant, may be configured to provide an indication, such as a vibration, a flashing screen, an alert message, or other indication via an interface to signal the proximity of the in-store assistant to the user 131 requesting assistance to help coordinate the assistance between the in-store assistant and user 131.

In another embodiment, upon determining that user 131 has remained in a particular location or area for a predetermined period of time, merchant server 122 may provide targeted interaction information to user 131 including specific product information relevant to the user's present location. For example, merchant server 122 may identify that user 131 has been detected in a section of the merchant environment where gas grills are provided on display. Merchant server 122 may access profile information of the user to determine whether the user has any relevant transaction information regarding gas grills or prior browsing history, or other profile information that may be relevant to the user's intent regarding a gas grill. Merchant server 122 may then determine a potential intent of user 131 based on the profile information and provide targeted interaction information based on the determined intent. For example, where merchant server 122 determines that user 131 may be interested in purchasing a grill, merchant server 122 may provide specific product information including user reviews, price comparisons, or discounts, etc. to help encourage the sale. In some embodiments, merchant server 122, based on transaction history received from service provider system 110, for example, may determine shopping patterns of user 131. For example, merchant server may be able to determine that in the past, user 131 has visited the merchant environment on numerous occasions to view certain products, but has completed a purchase of those products elsewhere. In this case, merchant server 122 may provide targeted interaction information to user 131 related to special discounts or other offers or information to help complete an in-store sale.

In some embodiments, the disclosed systems and methods may provide a virtual in-store shopping assistant. For example, upon detecting a user's location in a particular area of the merchant environment, such as the location of a fitting room, merchant server 122 may provide targeted interaction information to the user relevant to the user's trying on of particular items of clothing. In some embodiments, sensor system 124 may associate one or more clothing items with a user, based on, for example, communications between a tag associated with the item, similar to user tag 132. Merchant server 122 may provide targeted interaction information via an interface on client device 130 or via an interactive display (output device 234) in the fitting room, for example, enabling user selection of an item in a different size or color, etc. Based on a user selection, merchant server 122 may then direct an in-store assistant to provide the requested item to the user. In some embodiments, merchant server 122 may provide targeted interaction information regarding the remaining inventory at the merchant environment for the corresponding items as well as other merchant locations that may have greater inventory. In some embodiments, user 131 may be provided with targeted interaction information enabling the user to complete the purchase of the item for delivery to the user's home. Merchant server 122 may also suggest one or more other complementary items or alternative items that may have been determined to be relevant to the user based on the user's profile information, including information regarding the current interaction. Similar to the above, merchant server 122 may be able to identify a user's prior purchasing patterns to determine the nature of the targeted interaction information to further encourage a sale.

Numerous other scenarios may be implemented using the disclosed systems and methods. In some embodiments, similar to the above, sensor system 124 may associate one or more items with user 131. For example, in some embodiments, merchant server 122 may determine that user 131 is carrying one or more items or has one or more items in a shopping cart, for example, by detecting user interaction with an item and/or movement of the items in the merchant environment along with user 131. Merchant server 122 may then provide targeted interaction information to user 131 based on the detected items and the user's profile information. In some embodiments, merchant server 122 may provide targeted interaction information suggesting one or more other products related to the current identified products that perhaps the user has not purchased before but may be interested in, as may be determined based on the user's profile information. In some embodiments, merchant server 122 may provide targeted interaction information regarding another item that may qualify for a discount based on the current selection of items. Merchant server 122 may also provide targeted interaction information to user 131 regarding a rewards program, next milestones and suggested purchases to reach the milestone, etc. In these embodiments, merchant server 122 may also provide an interactive map directing the user to the location of the suggested item or items.

In some embodiments, another interaction phase may correspond to a “purchasing phase.” Sensor system 124 may detect a user's presence in a checkout area of the merchant environment and provide such location information to merchant server 122. Merchant server 122 may provide targeted interaction information to user 131 relevant to a checkout experience. In some embodiments, merchant server 122 may provide an indication of a particular checkout lane with the shortest wait time, as may be detected by sensor system 124, or a checkout lane or area at which the user may be able to retrieve one or more products selected for pick-up at the checkout, etc. Additionally, in some embodiments, merchant server 122 may determine from the user's profile information, transaction account information that may automatically be applied to the current transaction and any other rewards or discounts that may be available using an alternate transaction account or in conjunction with a merchant loyalty card, etc.

After user 131 completes a purchase, or if consumer does not purchase anything at all, sensor system 124 may detect a user's presence in an exit area of the merchant environment corresponding to a “post-purchase” or “exiting phase” of the current interaction. Based on the user's detected exit, merchant server 122 may again determine relevant targeted interaction information. In some embodiments, merchant server 122 may evaluate the user's pattern of movement throughout the environment on the current visit and/or prior visits to determine a potential intent of the user. For example, where merchant system 122 determines that the user viewed a particular product but ultimately did not purchase the product, user 131 may be presented with targeted interaction information requesting user input regarding the user's decision not to purchase, or direct the user to a web-site with a greater number of options or selections related to an item, provide additional offers or discounts associated with the item or other relevant information that may be determined based on the user's profile information.

The above examples are not limiting, and are provided to illustrate a few examples of potential targeted interaction information that may be provided to a user based on the user's detected movement and interaction within a merchant environment. Other types of targeted interaction information of varying content that may also be provided to a user based on the nature of goods or services of the merchant, for example, are within the scope of the disclosed systems and methods.

The disclosed systems and methods are not limited to providing targeted interaction information during a user's visit to the merchant environment. In some embodiments, merchant server 122 may evaluate user profile information to provide relevant targeted interaction information to a user even after the user has exited the merchant environment. As similarly discussed above, merchant server 122 may analyze and store information related to a user's movement and interaction with the merchant environment and one or more items or areas within the environment. Merchant server 122 may determine from this information possible user interest in an item or other purchasing patterns. For example, based on a user's interaction with the merchant environment, as detected by sensor system 124, merchant server 122 may determine that a user has viewed a particular item on several different visits. From this information, merchant server 122 may provide relevant targeted interaction information to user 131 outside of the merchant environment to notify the user of a current sale or promotional offer regarding the item determined to be of interest.

Additionally, in some embodiments, merchant server 122 may analyze user interaction information of a plurality of users within the merchant environment to determine general consumer behavior, for example. Based on this analysis, merchant server 122 may determine the general effectiveness of an advertisement campaign, or in-store displays and/or other techniques. For example, merchant server 122 may determine that a certain percentage of users who were exposed to a particular display or offer ultimately visited an area of the store relevant to the offer. Additionally, merchant server 122 may determine the number of consumers that ultimately completed a purchase in response to the advertisement or offer. Merchant server 122 may use this information to further refine an advertisement campaign or identify subsets of users for which the campaigns are most effective, etc. Over time, merchant server 122 may collect large amounts of data on the user interaction behavior and the effectiveness of certain sales techniques, store layouts, etc. From this information, merchant server 122 may provide numerous various types of targeted interaction information to enhance the user experience and drive sales.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, or any such programming languages. One or more of such software sections or modules can be integrated into a computer system, computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

What is claimed is:

1. A system for providing targeted interaction information to a user in an environment based on detection of a device associated with the user within the environment using a plurality of sensors positioned within the environment, the system comprising:
a memory storing a set of instructions; and
at least one processor configured to execute the set of instructions to:
determine location information of the device based on a communication between the device and at least one of the plurality of sensors;
determine identification information of the user associated with the device;
access profile information associated with the user;
determine targeted interaction information based on the location information of the device and the profile information associated with the user; and
provide the targeted interaction information for display to the user.

2. The system of claim 1, wherein the profile information of the user includes information corresponding to prior location information of the user within the environment determined during a prior interaction with the environment.

3. The system of claim 1, wherein the targeted interaction information is provided for display to the user via a display device present in the environment.

4. The system of claim 3, wherein the at least one processor is further configured to execute the set of instructions to determine whether the display device is within a predetermined proximity to the client device associated with the user based on the determined location information.

5. The system of claim 1, wherein the at least one processor is further configured to execute the set of instructions to identify an interaction phase of the user within the environment and determine targeted interaction information based on the interaction phase.

6. The system of claim 5, wherein the at least one processor is configured to access certain profile information of the user based on the identified interaction phase of the user within the environment.

7. The system of claim 1, wherein the at least one processor is configured to determine location information of the device based on a received identifier of the at least one of the plurality of sensors.

8. The system of claim 1, wherein the plurality of sensors positioned within the environment are configured to communicate with the device using a short-range communication protocol.

9. The system of claim 1, wherein the targeted interaction information is determined based on a detected movement of the client device within the environment.

10. The system of claim 1, wherein the targeted interaction information is determined based on a determination that a duration of the user's presence in a particular location exceeds a predetermined threshold.

11. The system of claim 1, wherein the device associated with the user includes a user tag.

12. The system of claim 1, wherein the device associated with the user includes a client device.

13. The system of claim 1, wherein the at least one of the plurality of sensors includes a beacon.

14. A computer-implemented method for providing targeted interaction information to a user in an environment, the method comprising:
receiving a communication from a client device associated with a user including a user identifier and a sensor identifier associated with at least one of a plurality of sensors positioned within the environment;
determining, by one or more processors, an identity of the user and a location of the user within the environment based on the communication;
accessing, by the one or more processors, profile information associated with the user;
determining, by the one or more processors, targeted interaction information for the user based on the identified location and the accessed profile information associated with the user; and
providing, by the one or more processors, the targeted interaction information for display to the user.

15. The method of claim 14, wherein the sensor identifier was received by the client device from a sensor positioned within the environment using a short-range communication protocol.

16. The method of claim 15, further comprising determining the location of the user based on a known location of the sensor associated with the received sensor identifier.

17. The method of claim 14, further comprising providing the targeted interaction information for display to the user via a display device present in the environment.

18. The method of claim 17, further comprising determining whether the display device is within a predetermined proximity to the user based on the determined location of the user.

19. The method of claim 14, further comprising:
determining an interaction phase of the user based on a user's detected movement within the environment; and
determining targeted interaction information based on the determined interaction phase.

20. A non-transitory computer-readable medium storing a set of instructions that are executable by one or more processors to cause the one or more processors to perform a method for providing targeted interaction information to a user in an environment, the method comprising:
determining a user identifier and a sensor identifier associated with at least one of a plurality of sensors positioned within the environment based on a communication from a device associated with a user with a sensor of the plurality of sensors;
determining an identity of the user and a location of the user within the environment based on the communication;
accessing profile information associated with the user;
determining targeted interaction information for the user based on the identified location and the accessed profile information associated with the user; and
providing the targeted interaction information for display to the user.

21. The non-transitory computer-readable medium of claim 17, wherein the method further comprises determining the location of the user based on a known location of a sensor associated with the received sensor identifier.

22. The non-transitory computer-readable medium of claim 17, wherein the method further comprises:
determining that a display device in the environment is within a predetermined proximity to the user to the determined location of the user; and
providing the targeted interaction information for display to the user via the display device.

23. The non-transitory computer-readable medium of claim 17, wherein the method further comprises:
providing the targeted interaction information for display to the user via a client device associated with the user.

24. The non-transitory computer-readable medium of claim 17, wherein the method further comprises:
determining an interaction phase of the user based on a user's detected movement within the environment; and
determining targeted interaction information based on the determined interaction phase.
